(19) United States
(12) Patent Application Publication
(10) Pub. No.: US 2020/0383853 A1
(43) Pub. Date: Dec. 10, 2020

(54) PATIENT SAFETY SURGICAL PADS AND METHODS OF MAKING AND USING THE SAME

(71) Applicant: GRI-ALLESET , INC., Flowery Branch, GA (US)

(72) Inventors: Cayd Ayres, Knoxville, TN (US); Brian E. Jenkins, Cumming, GA (US)

(21) Appl. No.: 16/894,336

(22) Filed: Jun. 5, 2020

Related U.S. Application Data
(60) Provisional application No. 62/857,488, filed on Jun. 5, 2019.

(51) Int. Cl. A61G 7/10; A61G 7/05; B32B 5/02; B32B 5/18; B32B 7/09; B32B 7/12; B32B 27/12; B32B 27/06; B32B 27/30

(52) U.S. Cl. CPC A61G 7/1023; B32B 2535/00; A61G 7/1073; B32B 5/02; B32B 5/18; B32B 7/09; B32B 7/12; B32B 27/12; B32B 27/065; B32B 27/304; B32B 2327/06; B32B 2266/0264; B32B 2266/0278; B32B 2307/744; A61G 7/05

(57) ABSTRACT

Patient safety surgical pads are disclosed. Methods of making and using patient safety surgical pads are also disclosed.

### CROSS-REFERENCE TO RELATED APPLICATIONS

This patent application claims the benefit of priority to U.S. Provisional Patent Application Ser. No. 62/857,488 filed on Jun. 5, 2019 and entitled “PATIENT SAFETY SURGICAL PADS AND METHODS OF MAKING AND USING THE SAME,” the subject matter of which is hereby incorporated by reference in its entirety.

### FIELD OF THE INVENTION

The present invention relates generally to patient safety surgical pads for use in a hospital setting. The present invention further relates to methods of making and using the patient safety surgical pads.

### BACKGROUND OF THE INVENTION

There is a need in the art for simple, effective, safe and patient/staff-friendly patient safety surgical pads.

### SUMMARY OF THE INVENTION

The present invention is directed to simple, effective, safe and environmentally-friendly patient safety surgical pads. The disclosed patient safety surgical pads enable efficient and safe transfer/transport of a patient in a hospital or clinical setting.

In one exemplary embodiment, the patient safety surgical pads of the present invention comprise a fiber-containing layer having an upper fiber-containing layer surface and a lower fiber-containing layer surface; a high coefficient of friction layer along the lower fiber-containing layer surface; and a foam layer along the upper fiber-containing layer surface. In some embodiments, the patient safety surgical pad is capable of supporting and/or transporting and/or enabling transfer of a patient having a patient weight of up to about 400 kilograms (kg) (i.e., about 880 pounds (lbs)).

The present invention is further directed to methods of making patient safety surgical pads. In one exemplary embodiment, the method of making patient safety surgical pads comprises: attaching a high coefficient of friction layer along a lower fiber-containing layer surface of a fiber-containing layer; and attaching a foam layer along an upper fiber-containing layer surface of the fiber-containing layer. In some embodiments, the method of making the patient safety surgical pad comprises: attaching the high coefficient of friction layer along the lower fiber-containing layer surface of the fiber-containing layer; and attaching the foam layer along the upper fiber-containing layer surface of the fiber-containing layer, wherein the method further comprise one or more optional features and/or steps comprising: (1) the foam layer comprises two or more foam layers, and the method further comprises combining the two or more foam layers with one another; (2) each of said attaching steps comprises utilizing an adhesive to attach the high coefficient of friction layer and the foam layer to the fiber-containing layer; (3) stitching one or more layers to one another via stitching; (4) the step of attaching the high coefficient of friction layer along the lower fiber-containing layer surface of the fiber-containing layer comprises attaching a high coefficient of friction layer that has a length L_{HL} that is less than an overall length L_{O} of the fiber-containing layer; and (5) a lower surface portion of the lower fiber-containing layer surface is (i) below the foam layer and (ii) not covered by the high coefficient of friction layer.

The present invention is further directed to methods of using patient safety surgical pads. In one exemplary embodiment, the method of using patient safety surgical pads comprises: positioning a patient safety surgical pad along an operating room table, the patient safety surgical pad comprising a fiber-containing layer having an upper fiber-containing layer surface and a lower fiber-containing layer surface; a high coefficient of friction layer along the lower fiber-containing layer surface; and a foam layer along the upper fiber-containing layer surface. In some embodiments, the methods of using patient safety surgical pads comprise one or more steps comprising: supporting a patient on the patient safety surgical pad; positioning the patient safety surgical pad along an operating room table; lifting a patient via the patient safety surgical pad; transferring a patient from one location to another location via the patient safety surgical pad; and cutting thru a lower surface portion of the patient safety surgical pad, the lower surface portion being (i) below the foam layer and (ii) not covered by the high coefficient of friction layer.

These and other features and advantages of the present invention will become apparent after a review of the following detailed description of the disclosed embodiments and the appended claims.

### BRIEF DESCRIPTION OF THE FIGURES

The present invention is further described with reference to the appended figure, wherein:

FIG. 1 depicts a perspective view of an exemplary patient safety surgical pad of the present invention;

FIG. 2 depicts a cross-sectional view of the exemplary patient safety surgical pad shown in FIG. 1 as viewed along line 2-2 shown in FIG. 1;

FIG. 3 depicts a close-up view of the cross-section circled in area “3” as shown in FIG. 2; and

FIGS. 4A-4C depict views of another exemplary patient safety surgical pad of the present invention.

### DETAILED DESCRIPTION OF THE INVENTION

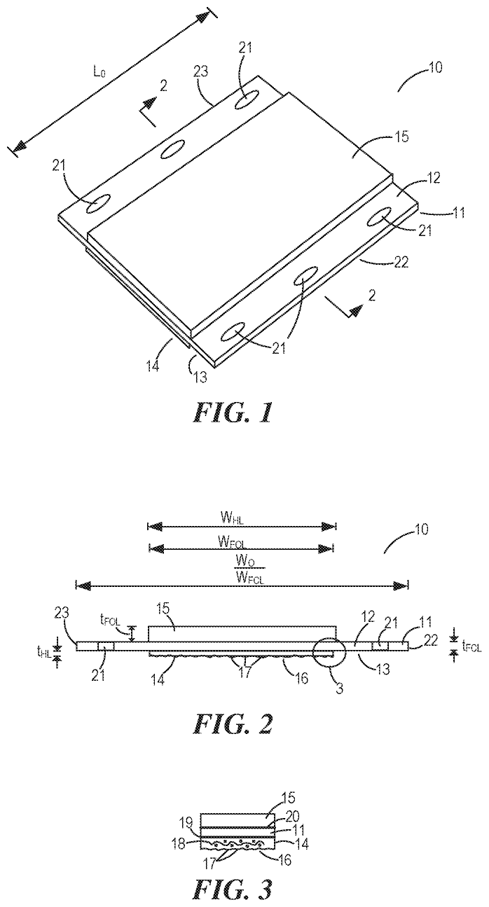

The present invention is directed to patient safety surgical pads, methods of making patient safety surgical pads, and methods of using patient safety surgical pads. An exemplary patient safety surgical pad 10 of the present invention is shown in FIG. 1. As shown in FIG. 1, exemplary patient safety surgical pad 10 comprises: a fiber-containing layer 11 having an upper fiber-containing layer surface 12 and a lower fiber-containing layer surface 13; a high coefficient of friction layer 14 along the lower fiber-containing layer surface 13; and a foam layer 15 along the upper fiber-containing layer surface 12. As discussed further below, fiber-containing layer 11 may comprise one or more nonwoven layers 11, one or more woven layers 11, one or more knit layers 11, one or more unidirectional fiber layers 11, or any combination thereof. In addition, foam layer 15 may comprise a single foam layer 15 or multiple (i.e., two or more) foam layers with each foam layer 15 providing a desired property to the exemplary patient safety surgical pad 10.

The present invention will be further described in the following additional embodiments, examples, and claims.

### Additional Embodiments:

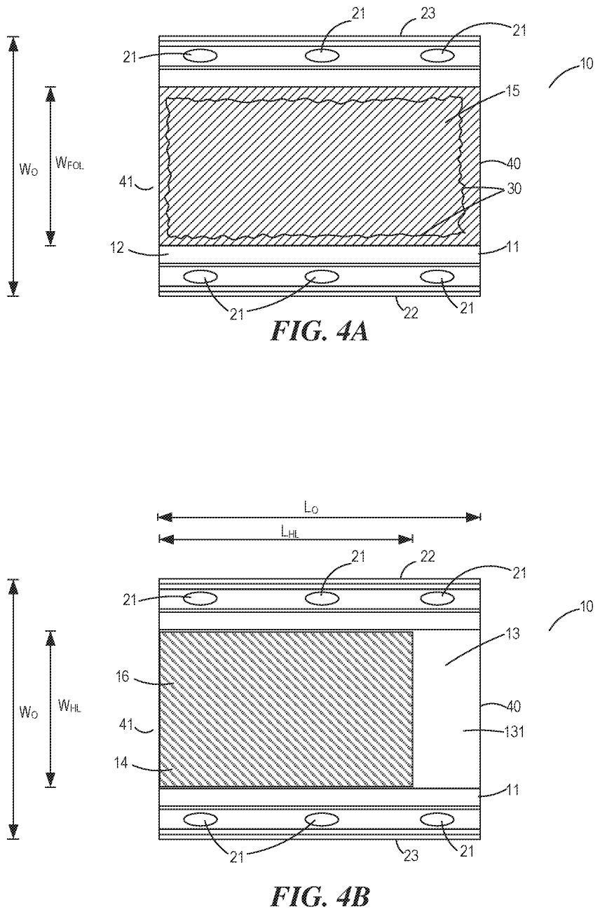

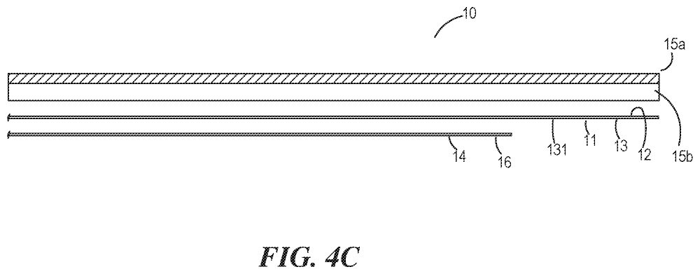

Patient Safety Surgical Pads
1. A patient safety surgical pad 10 comprising: a fiber-containing layer 11 having an upper fiber-containing layer surface 12 and a lower fiber-containing layer surface 13; a high coefficient of friction layer 14 along the lower fiber-containing layer surface 13; and a foam layer 15 along the upper fiber-containing layer surface 12. As used herein, the phrase “a high coefficient of friction” refers to a surface having a coefficient of friction (e.g., a static friction coefficient and a dynamic friction coefficient) of at least about 1.0 as measured via ASTM test method D1894 (i.e., with a speed of 150 mm/min, a force of 200 g, and as measured against a stainless steel surface). In some more desired cases, the high coefficient of friction layer 14 has a coefficient of friction (e.g., a static friction coefficient and a dynamic friction coefficient) of at least about 1.2 (or at least about 1.3, or at least about 1.4, or at least about 1.5, or any value between 1.0 and above, e.g., up to about 2.5, in increments of 0.1, as measured via the ASTM test method D1894 described above.
2. The patient safety surgical pad 10 of embodiment 1, wherein the fiber-containing layer 11 comprises one or more nonwoven layers 11, one or more woven layers 11, one or more knit layers 11, one or more unidirectional fiber layers 11, or any combination thereof.
3. The patient safety surgical pad 10 of embodiment 1 or 2, wherein the fiber-containing layer 11 comprises one or more nonwoven layers 11.
4. The patient safety surgical pad 10 of any one of embodiments 1 to 3, wherein the fiber-containing layer 11 comprises a spunbonded nonwoven 11 or a spunbonded/meltblown/spunbonded (SMS) nonwoven 11.
5. The patient safety surgical pad 10 of any one of embodiments 1 to 4, wherein the fiber-containing layer 11 comprises at least one layer of a spunbonded nonwoven 11 comprising polypropylene fibers.
6. The patient safety surgical pad 10 of any one of embodiments 1 to 5, wherein the fiber-containing layer 11 has a layer thickness t_{FCL} of from about 0.5 millimeter (mm) to about 3.0 mm.
7. The patient safety surgical pad 10 of any one of embodiments 1 to 6, wherein the high coefficient of friction layer 14 comprises a polymeric layer 14.
8. The patient safety surgical pad 10 of any one of embodiments 1 to 7, wherein the high coefficient of friction layer 14 comprises polyvinyl chloride. In some embodiments, the polyvinyl chloride layer has a coefficient of friction (e.g., a static friction coefficient and a dynamic friction coefficient) of about 1.5 as measured via the ASTM test method D1894 described above (i.e., with a speed of 150 mm/min, a force of 200 g, and as measured against a stainless steel surface). For example, some polyvinyl chloride layers provide a static friction coefficient of about 1.50 and a dynamic friction coefficient of about 1.88 using the ASTM test method D1894 described above.
9. The patient safety surgical pad 10 of any one of embodiments 1 to 8, wherein the high coefficient of friction layer 14 comprises a textured outermost surface 16 having undulations 17 along the outermost surface 16.
10. The patient safety surgical pad 10 of any one of embodiments 7 to 9, wherein the high coefficient of friction layer 14 further comprises a fibrous reinforcement 18 within or bonded to said polymeric layer 14. See, for example, FIG. 3.
11. The patient safety surgical pad 10 of embodiment 10, wherein the fibrous reinforcement 18 comprises a polyester knit fabric 18 calendared within and/or onto said polymeric layer 14, said polyester knit fabric 18 having a warp tear strength of about 2.5 kg and a weft tear strength of about 1.8 kg as measured by ASTM D751 test method.
12. The patient safety surgical pad 10 of any one of embodiments 1 to 11, wherein the high coefficient of friction layer 14 has a layer thickness t_{HL} of from about 0.3 mm to about 1.0 mm.
13. The patient safety surgical pad 10 of any one of embodiments 1 to 12, wherein the high coefficient of friction layer 14 has a layer thickness t_{HL} of about 0.8 mm.
14. The patient safety surgical pad 10 of any one of embodiments 1 to 13, wherein the foam layer 15 comprises a single foam layer 15. See, for example, FIG. 2.
15. The patient safety surgical pad 10 of any one of embodiments 1 to 13, wherein the foam layer 15 comprises two or more foam layers 15 in combination with one another. See, for example, exemplary patient safety surgical pad 10 shown in FIGS. 4A-4C. FIG. 4A provides a top view of exemplary patient safety surgical pad 10. FIG. 4B provides a bottom view of exemplary patient safety surgical pad 10. FIG. 4C provides a side view of the various layers used to form exemplary patient safety surgical pad 10.
16. The patient safety surgical pad 10 of any one of embodiments 1 to 13 and 15, wherein the foam layer 15 comprises two foam layers 15 in combination with one another.
17. The patient safety surgical pad 10 of any one of embodiments 1 to 16, wherein the foam layer 15 has a layer density of from about 0.5 to about 5.0 lb density (or any value or range of values between 0.5 and 5.0 lb, in increments of 0.1 lb). As used herein, the foam density describes the weight of a one cubic foot block of a given foam.
18. The patient safety surgical pad 10 of any one of embodiments 1 to 17, wherein the foam layer 15 has a layer density of from about 2.5 to about 4.0 lb density (or any value or range of values between 2.5 and 4.0 lb, in increments of 0.1 lb).
19. The patient safety surgical pad 10 of any one of embodiments 1 to 18, wherein the foam layer 15 has an Impression Load Deflection (ILD) value of from about 36 to about 50 (or any value or range of values between 36 and 50, in increments of 1.0).
20. The patient safety surgical pad 10 of any one of embodiments 1 to 19, wherein the foam layer 15 has an Impression Load Deflection (ILD) value of from about 40 to about 50.
21. The patient safety surgical pad 10 of any one of embodiments 1 to 20, wherein the foam layer 15 has a layer thickness t_{FOL} of from about 1.0 inches (in) to about 4.0 in.
22. The patient safety surgical pad 10 of any one of embodiments 1 to 21, wherein the foam layer 15 has a layer thickness t_{FOL} of from about 1.0 in to about 2.0 in.
23. The patient safety surgical pad 10 of any one of embodiments 1 to 22, wherein the foam layer 15 comprises a polyurethane foam 15, a polyester foam 15, a polyester polyurethane foam 15, or a combination thereof.
24. The patient safety surgical pad 10 of any one of embodiments 1 to 23, wherein the foam layer 15 comprises a polyurethane non-viscoelastic foam 15, a polyester non-viscoelastic foam 15, a polyester polyurethane non-viscoelastic foam 15, or a combination thereof.
25. The patient safety surgical pad 10 of any one of embodiments 1 to 13 and 15 to 24, wherein the foam layer 15 comprises (i) an upper foam layer 15a having an upper foam layer thickness of from about 0.25 in to about 1.0 in, and (ii) a lower foam layer 15b having a lower foam layer thickness of from about 0.5 in to about 1.5 in. See, for example, FIG. 4C.
26. The patient safety surgical pad 10 of embodiment 25, wherein (i) the upper foam layer 15a has a high tack coefficient (e.g., a static friction coefficient and a dynamic friction coefficient) of at least 1.0 as measured via the ASTM test method D1894 described above (i.e., with a speed of 150 mm/min, a force of 200 g, and as measured against a stainless steel surface), and (ii) the lower foam layer 15b has an average breathability of at least about 3.0 standard cubic feet per minute (SCFM) as measured via ASTM 3574 Test G. See again, FIG. 4C. In some cases, the high tack coefficient of the upper foam layer 15a (e.g., the static friction coefficient and the dynamic friction coefficient as measured using the ASTM test method D1894 described above) is greater than about 1.1 (or at least about 1.3, or at least about 1.4, or at least about 1.5, or any value between 1.0 and above, e.g., up to about 2.5, in increments of 0.1, as measured via the ASTM test method D1894 described above. In some cases, the lower foam layer 15b has an average breathability of at least about 3.5 (or about 4.0, or about 4.5, or about 5.0 or about 5.5 or greater) SCFM as measured via ASTM 3574 Test G. It should be noted that the upper foam layer 15a desirably has an average breathability of at least about 0.5 (or about 0.6, or about 0.7, or about 0.8 or about 1.2 or greater) SCFM as measured via. ASTM 3574 Test G.
27. The patient safety surgical pad 10 of embodiment 25 or 26, wherein (i) the upper foam layer 15a has an Impression Load Deflection (ILD) value of about 50, and (ii) the lower foam layer 15b has an Impression Load Deflection (ILD) value of about 40.
28. The patient safety surgical pad 10 of any one of embodiments 25 to 27, wherein (i) the upper foam layer 15a comprises a polyester polyurethane non-viscoelastic foam 15a, and (ii) the lower foam layer 15b comprises a polyurethane non-viscoelastic foam 15b.
29. The patient safety surgical pad 10 of any one of embodiments 1 to 28, further comprising a first adhesive layer 19 between the high coefficient of friction layer 14 and the lower fiber-containing layer surface 13 of the fiber-containing layer 11. It should be understood that although a first adhesive layer 19 is not shown in FIG. 4C, the depicted exemplary patient safety surgical pad 10 could also have a first adhesive layer 19 between the high coefficient of friction layer 14 and the lower fiber-containing layer surface 13 of the fiber-containing layer 11.
30. The patient safety surgical pad 10 of any one of embodiments 1 to 29, further comprising a second adhesive layer 20 between the foam layer 15 and the upper fiber-containing layer surface 12 of the fiber-containing layer 11. See, FIG. 3. It should be understood that although a second adhesive layer 20 is not shown in FIG. 4C, the depicted exemplary patient safety surgical pad 10 could also have a second adhesive layer 20 between the foam layer 15 and the upper fiber-containing layer surface 12 of the fiber-containing layer 11. For both the first adhesive layer 19 and the second adhesive layer 20, these adhesive layers can be provided in a continuous layer so as to substantially cover an entire area between adjacent layers (e.g., between foam layer 15 and the upper fiber-containing layer surface 12 of the fiber-containing layer 11). Alternatively, each of the first adhesive layer 19 and the second adhesive layer 20 may be applied so as to provide a patterned adhesive layer that covers less than an entire area between adjacent layers (e.g., between foam layer 15 and the upper fiber-containing layer surface 12 of the fiber-containing layer 11). Such a patterned adhesive layer allows more breathability between adjacent layers (e.g., between foam layer 15 and the upper fiber-containing layer surface 12 of the fiber-containing layer 11). In addition, each of first adhesive layer 19 and second adhesive layer 20 may independently comprise any adhesive suitable for bonding foam layers, fiber-containing layers and high coefficient of friction layer to one another. Desirably, the first adhesive layer 19 and the second adhesive layer 20 comprise GREENGUARD™ certified adhesives. Suitable adhesives for the first adhesive layer 19 and the second adhesive layer 20 include, but are not limited to, water-based, high tack adhesives such as those comprising dispersions of acrylic resin and/or synthetic rubber in water. These types of adhesives are available from a number of manufacturers/sources.
31. The patient safety surgical pad 10 of embodiment 30, wherein the second adhesive layer 20 comprises a patterned adhesive layer 20 that covers less than an entire area between the foam layer 15 and the upper fiber-containing layer surface 12 of the fiber-containing layer 11.
32. The patient safety surgical pad 10 of any one of embodiments 1 to 31, further comprising stitching 30 so as to secure two or more layers to one another. See, for example, exemplary stitching 30 in FIG. 4A.
33. The patient safety surgical pad 10 of embodiment 32, wherein the stitching 30 secures two foam layers to one another (e.g., upper foam layer 15a to lower foam layer 15b).
34. The patient safety surgical pad 10 of embodiment 32 or 33, wherein the stitching 30 secures one or more foam layers 15 to the fiber-containing layer 11.
35. The patient safety surgical pad 10 of any one of embodiments 32 to 34, wherein the stitching 30 secures one or more foam layers 15 to the fiber-containing layer 11 and the friction layer 14.
36. The patient safety surgical pad 10 of any one of embodiments 32 to 35, wherein the stitching 30 extends along at least one edge of the foam layer 15. It should be understood that the stitching 30 could be positioned any distance from the at least one edge of the foam layer 15.
37. The patient safety surgical pad 10 of any one of embodiments 32 to 36, wherein the stitching 30 extends along at least two edges of the foam layer 15.
38. The patient safety surgical pad 10 of any one of embodiments 32 to 37, wherein the stitching 30 extends along each edge of the foam layer 15. Although not shown, it should be understood that additional stitching 30 could be used along any portion of the foam layer 15 (e.g., in a central portion) and have any desired stitching pattern along the foam layer 15.
39. The patient safety surgical pad 10 of any one of embodiments 1 to 38, further comprising one or more handles 21 positioned along opposite side edges 22/23 of the patient safety surgical pad 10.
40. The patient safety surgical pad 10 of any one of embodiments 1 to 39, further comprising one or more handles 21 positioned along opposite side edges 22/23 of the patient safety surgical pad 10 and within the fiber-containing layer 11.
41. The patient safety surgical pad 10 of embodiment 39 or 40, wherein each handle 21 may independently have a desired shape and size. See, for example, FIG. 4A, wherein centrally located handles 21 have a larger size and more oblong shape that the handles 21 at opposite edges of the fiber-containing layer 11.
42. The patient safety surgical pad 10 of any one of embodiments 1 to 41, wherein the patient safety surgical pad 10 is capable of supporting and/or transporting and/or enabling transfer of a patient (not shown) having a patient weight of up to about 400 kilograms (kg) (i.e., about 880 pounds (lbs)).
43. The patient safety surgical pad 10 of any one of embodiments 1 to 42, wherein the patient safety surgical pad 10 has an overall width Wₒ of from about 16 in to about 40 in, and an overall length L_{O} of from about 24 in to about 60 in. It should be understood that the overall width Wₒ could be any value between 16 in and 40 in, in increments of 0.1 in, e.g., 33.0 in, or any range of values between 16 in and 40 in, in increments of 0.1 in, e.g., from about 30.4 in to about 35.8 in. Likewise, the overall length L_{O} could be any value between 24 in and 60 in, in increments of 0.1 in, e.g., 35.0 in, or any range of values between 24 in and 60 in, in increments of 0.1 in, e.g., from about 38.4 in to about 40.0 in.
44. The patient safety surgical pad 10 of any one of embodiments 1 to 43, wherein the patient safety surgical pad 10 has an overall width Wₒ about 33 in, and an overall length L_{O} of about 40 in.
45. The patient safety surgical pad 10 of any one of embodiments 1 to 44, wherein the foam layer 15 has an overall width W_{FOL} that is less than an overall width W_{FCL} of the fiber-containing layer 11. It should be understood that the overall width W_{FOL} of foam layer 15 may be any value less than the overall width W_{FCL} of the fiber-containing layer 11. Typically, the overall width W_{FOL} of foam layer 15 is from about 10 in to 16 in less than the overall width W_{FCL} of the fiber-containing layer 11 (e.g., an overall width W_{FOL} of foam layer 15 of about 20 in and an overall width W_{FCL} of the fiber-containing layer 11 of about 33 in).
46. The patient safety surgical pad 10 of any one of embodiments 1 to 45, wherein the high coefficient of friction layer 14 has an overall width W_{HL}. that is less than an overall width W_{FCL} of the fiber-containing layer 11. It should be understood that the overall width of each layer may be the same or different from one or more of the other layers. For example, in some embodiments, the foam layer 15 and the high coefficient of friction layer 14 may have a substantially similar or equal overall width (i.e., W_{FOL}=W_{HL}) that is less than the overall width W_{FCL} of the fiber-containing layer 11. In other embodiments, the high coefficient of friction layer 14 may have an overall width W_{HL}. that is less than the overall width W_{FOL} of foam layer 15 while the overall width W_{FOL} of foam layer 15 is less than the overall W_{FCL} of the fiber-containing layer 11. Further, in other embodiments, the high coefficient of friction layer 14 may have an overall width W_{HL}. that is greater than the overall width W_{FOL} of foam layer 15 while the overall width W_{FOL} of foam layer 15 is less than the overall W_{FCL} of the fiber-containing layer 11.
47. The patient safety surgical pad 10 of any one of embodiments 1 to 46, wherein the high coefficient of friction layer 14 has a width WHL that is greater than an overall width W_{FOL} of foam layer 15. See, for example, FIGS. 4A-4B.
48. The patient safety surgical pad 10 of any one of embodiments 1 to 47, wherein the high coefficient of friction layer 14 has a length L_{HL} that is less than an overall length L_{O} of the fiber-containing layer 11. See, for example, FIG. 4B.
49. The patient safety surgical pad 10 of any one of embodiments 1 to 48, wherein the high coefficient of friction layer 14 has a length L_{HL}. that is from about 8 to about 12 in less than an overall length L_{O} of the fiber-containing layer 11. See again, FIG. 4B.
50. The patient safety surgical pad 10 of any one of embodiments 1 to 49, wherein a lower surface portion 131 of the lower fiber-containing layer surface 13 is (i) below the foam layer and (ii) not covered by the high coefficient of friction layer 14. See again, FIG. 4B.
51. The patient safety surgical pad 10 of embodiment 50, wherein the lower surface portion 131 is positioned along a head end 40, along a foot end 41, or both. Although not shown, one or more markers or symbols (or other identifiers) may be used to designate the head end 40, the foot end 41, or both.

Methods of Making Patient Safety Surgical Pads
52. A method of making the patient safety surgical pad 10 of any one of embodiments 1 to 51, said method comprising: attaching the high coefficient of friction layer 14 along the lower fiber-containing layer surface 13 of the fiber-containing layer 11; and attaching the foam layer 15 along the upper fiber-containing layer surface 12 of the fiber-containing layer 11.
53. The method of embodiment 52, wherein the foam layer 15 comprises two or more foam layers, and the method further comprises combining the two or more foam layers 15 with one another.
54. The method of embodiment 52 or 53, wherein each of said attaching steps comprises utilizing an adhesive 19/20 to attach the high coefficient of friction layer 14 and the foam layer 15 to the fiber-containing layer 11.
55. The method of any one of embodiments 52 to 54, further comprising stitching one or more layers to one another via stitching 30.
56. The method of any one of embodiments 52 to 55, wherein the step of attaching the high coefficient of friction layer 14 along the lower fiber-containing layer surface 13 of the fiber-containing layer 11 comprises attaching a high coefficient of friction layer 14 that has a length L_{HL} that is less than an overall length L_{O} of the fiber-containing layer 11. See again, FIG. 4B.
57. The method of any one of embodiments 52 to 56, wherein a lower surface portion 131 of the lower fiber-containing layer surface 13 is (i) below the foam layer and (ii) not covered by the high coefficient of friction layer 14. See again, FIG. 4B.

Methods of Using Patient Safety Surgical Pads
58. A method of using the patient safety surgical pad 10 of any one of embodiments 1 to 51, said method comprising: supporting a patient on the patient safety surgical pad 10.
59.The method of embodiment 58, further comprising positioning the patient safety surgical pad 10 along an operating room table (not shown).
60. The method of embodiment 58 or 59, further comprising lifting a patient via the patient safety surgical pad 10.
61. The method of any one of embodiments 58 to 60, further comprising transferring a patient from one location to another location via the patient safety surgical pad 10.
62. The method of any one of embodiments 58 to 61, further comprising cutting thru a portion of the patient safety surgical pad 10.
63. The method of any one of embodiments 58 to 62, further comprising cutting thru the lower surface portion 131 of the patient safety surgical pad 10.

In addition, it should be understood that although the above-described patient safety surgical pads 10 and methods (i.e., methods of making and using patient safety surgical pads 10) are described as “comprising” one or more components or steps, the above-described patient safety surgical pads 10 and methods may “comprise,” “consists of,” or “consist essentially of” the above-described components or steps of the patient safety surgical pads 10 and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a patient safety surgical pad 10 and/or method that “comprises” a list of elements (e.g., components or steps) is not necessarily limited to only those elements (or components or steps), but may include other elements (or components or steps) not expressly listed or inherent to the patient safety surgical pad 10 and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a patient safety surgical pad 10 and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described patient safety surgical pads 10 and/or methods may comprise, consist essentially of, or consist of any of the herein-described components and features, as shown in the figures with or without any feature(s) not shown in the figures. In other words, in some embodiments, the patient safety surgical pads 10 of the present invention do not have any additional features other than those shown in the figures, and such additional features, not shown in the figures, are specifically excluded from the patient safety surgical pads 10. In other embodiments, the patient safety surgical pads 10 of the present invention do have one or more additional features that are not shown in the figures.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

### Patient Safety Surgical Pads

An exemplary patient safety surgical pad 10 as shown in FIGS. 1-2 and described herein was prepared. Three (3) specifically engineered materials with individual layer functionality were combined into one multi-purpose patient safety surgical pad 10. In particular, (1) a foam topper 15 for patient comfort and tissue viability, (2) a heavy-weight SMS patient transfer sheet 11, and (3) a non-skid base 14 to prevent movement on the surgical table in any surgical position were combined with one another.

The exemplary patient safety surgical pad 10 had the following general dimensions: 45″ (length)×25″ (width). The top foam layer 15 provided a patient comfort/tissue viability portion of the pad 10, and comprised of a 1-2″ tall, 1.5-2.5 lb density, 36-50 ILD, quality polyurethane non-viscoelastic foam for excellent support while also very breathable. In some of the patient safety surgical pad samples 10 formed in this example, the foam layer 15 was a polyurethane foam having the following properties: a density of about 2.5, an ILD of from 36 to 44, a resilience (% rebound) of 45 to 55, a tear resistance (lb/in) of 1.5 to 2.5, a static fatigue % Loss at 25% ILD of less than 25, and a static fatigue % Loss in thickness of less than 5. These types of foams are available from a number of manufacturers.

The middle layer 11 provided a patient transfer sheet portion of the pad 10, and comprised heavy-weight SMS non-woven 11 so as to accommodate patients weighing up to 400 kgs (880 lbs). The bottom layer 14 provided non-skid properties to the pad 10, and comprised polyvinyl chloride (PVC) material 14, which was specifically designed to provide a high coefficient of friction.

The PVC material 14 was glued to the lower major surface 13 of the patient transfer sheet (middle layer) 11. The top foam layer 15 was also glued to the upper major surface 12 of the patient transfer sheet (middle layer) 11.

### EXAMPLE 2

### Patient Safety Surgical Pads

An exemplary patient safety surgical pad 10 as shown in FIGS. 4A-4C and described herein was prepared. In this example, two foam layers were combined with the heavy-weight SMS patient transfer sheet 11, and the non-skid base 14 used in Example 1. The two foam layers comprised: (1) an upper polyester non-viscoelastic foam layer having a high tack coefficient and a layer thickness of 0.5 in, and (2) a lower polyurethane non-viscoelastic foam layer having good breathability and a layer thickness of 1.5 in.

In some of the patient safety surgical pad samples 10 formed in this example, the lower foam layer 15 was the above-described polyurethane foam used in Example 1, while the upper foam layer was a polyester polyurethane foam having the following properties: an average density of about 4.0 lb/ft³ (64.08 kg/m³), an average tensile strength of about 20.0 psi (138 kPa), an average elongation 215%, an average tear resistance of 2.0 pli (350 N/M), an average compression force deflection at 25% deflection of 0.65 psi (4.5 kN/M²), and an average compression force deflection at 50% deflection of 0.85 psi (5.9 kN/M²). These types of foams are available from a number of manufacturers.

The exemplary patient safety surgical pad 10 had the following general dimensions: 40″ (length)×33″ (width). The upper foam layer 15a provided a high tack with a patient (e.g., a high tack coefficient of at least 1.50 as measured via the ASTM test method D1894 described above (i.e., with a speed of 150 mm/min, a force of 200 g, and as measured against a stainless steel surface)). The lower foam layer 15b provided excellent support while also being very breathable (e.g., with an average breathability of at least 5.5 standard cubic feet per minute (SCFM) as measured via ASTM 3574 Test G). The middle layer 11 provided a patient transfer sheet portion of the pad 10 so as to accommodate patients weighing up to 400 kgs (880 lbs). The bottom layer 14 provided non-skid properties to the pad 10.

The PVC material 14 was glued to the lower major surface 13 of the patient transfer sheet (middle layer) 11 so as to provide an uncovered lower surface portion 131 of the patient safety surgical pad 10. The lower foam layer 15 was also glued to the upper major surface 12 of the patient transfer sheet (middle layer) 11. In some versions, stitching 30 was also used to supplement the adhesive bonding between layers.

### EXAMPLE 3

### Coefficient of Friction Testing of Foam Layer Suitable for use in Patient Safety Surgical Pads

The following test was utilized to determine a coefficient of friction for a given foam layer.

A 15.4 lb steel weight was attached to a pull scale with digital gauge to test how much force it takes to slide the steel weight from a standstill when positioned on various surfaces. Two surfaces were tested: (1) a non-skid material typically used as a surgical table contact layer, and (2) the polyester polyurethane foam used as the lower foam layer in Example 2. The results are shown in the table below:

| | | 4.0Fine |
|---|---|---|
| | | Polyester |
| Test | Non-skid | Polyurethane |
| Sample No. | Material | Foam |
| 1 | 8 lbs 6 oz | 12 lbs 11 oz |
| 2 | 8 lbs 9 oz | 13 lbs 2 oz |
| 3 | 8 lbs 4 oz | 13 lbs 5 oz |
| 4 | 8 lbs 5 oz | 13 lbs 1 oz |

The present invention is described above and further illustrated below by way of claims, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

What is claimed is:

1. A patient safety surgical pad comprising:
a fiber-containing layer having an upper fiber-containing layer surface and a lower fiber-containing layer surface;
a high coefficient of friction layer along the lower fiber-containing layer surface; and
a foam layer along the upper fiber-containing layer surface.

2. The patient safety surgical pad of claim 1, wherein (a) the fiber-containing layer comprises one or more nonwoven layers, one or more woven layers, one or more knit layers, one or more unidirectional fiber layers, or any combination thereof and (b) the high coefficient of friction layer comprises a polymeric layer.

3. The patient safety surgical pad of claim 2, wherein the high coefficient of friction layer comprises polyvinyl chloride.

4. The patient safety surgical pad of claim 3, wherein the high coefficient of friction layer further comprises a fibrous reinforcement within or bonded to said polymeric layer.

5. The patient safety surgical pad of claim 1, wherein the foam layer comprises a polyurethane non-viscoelastic foam, a polyester non-viscoelastic foam, a polyester polyurethane non-viscoelastic foam, or a combination thereof.

6. The patient safety surgical pad of claim 1, wherein the foam layer comprises (a) an upper foam layer having (i) an upper foam layer thickness of from about 0.25 in to about 1.0 in, and (ii) a high tack coefficient of at least 1.50 as measured via ASTM test method D1894, and (b) a lower foam layer having (i) a lower foam layer thickness of from about 0.5 in to about 1.5 in, and (ii) an average breathability of about 5.5 standard cubic feet per minute (SCFM) as measured via ASTM 3574 Test G.

7. The patient safety surgical pad of claim 6, wherein the foam layer comprises (a) an upper foam layer having an Impression Load Deflection (ILD) value of about 50, and (b) a lower foam layer having an Impression Load Deflection (ILD) value of about 40.

8. The patient safety surgical pad of any claim 7, wherein (i) the upper foam layer comprises a polyester polyurethane non-viscoelastic foam, and (ii) the lower foam layer comprises a polyurethane non-viscoelastic foam.

9. The patient safety surgical pad of claim 1, further comprising (a) a first adhesive layer between the high coefficient of friction layer and the lower fiber-containing layer surface of the fiber-containing layer; and (b) a second adhesive layer between the foam layer and the upper fiber-containing layer surface of the fiber-containing layer.

10. The patient safety surgical pad of claim 9, wherein the second adhesive layer comprises a patterned adhesive layer that covers less than an entire area between the foam layer and the upper fiber-containing layer surface of the fiber-containing layer.

11. The patient safety surgical pad of claim 1, further comprising stitching so as to secure two or more layers to one another.

12. The patient safety surgical pad of claim 1, further comprising one or more handles positioned along opposite side edges of the patient safety surgical pad and within the fiber-containing layer.

13. The patient safety surgical pad of claim 1, wherein the patient safety surgical pad is capable of supporting and/or transporting and/or enabling transfer of a patient having a patient weight of up to about 400 kilograms (kg) (i.e., about 880 pounds (lbs)).

14. The patient safety surgical pad of claim 1, wherein (a) the foam layer has an overall width W_{FOL} that is less than an overall width W_{FCL} of the fiber-containing layer; and (b) the high coefficient of friction layer has (i) an overall width W_{HL}. that is less than an overall width W_{FCL} of the fiber-containing layer, and (ii) a length Lm. that is less than an overall length L_{O} of the fiber-containing layer.

15. The patient safety surgical pad of claim 1, wherein a lower surface portion of the lower fiber-containing layer surface is (i) below the foam layer and (ii) not covered by the high coefficient of friction layer.

16. A patient safety surgical pad comprising:
a fiber-containing layer having an upper fiber-containing layer surface and a lower fiber-containing layer surface;
a high coefficient of friction layer along the lower fiber-containing layer surface; and
a foam layer along the upper fiber-containing layer surface;
wherein the patient safety surgical pad is capable of supporting, transporting, enabling transfer of a patient having a patient weight of up to about 400 kilograms (kg).

17. The patient safety surgical pad of claim 16, wherein (a) the foam layer has an overall width W_{FOL} that is less than an overall width W_{FCL} of the fiber-containing layer; and (b) the high coefficient of friction layer has (i) an overall width W_{HL}. that is less than an overall width W_{FCL} of the fiber-containing layer, and (ii) a length L_{HL} that is less than an overall length L_{O} of the fiber-containing layer.

18. The patient safety surgical pad of claim 17, wherein the foam layer comprises (a) an upper foam layer having (i) an upper foam layer thickness of from about 0.25 in to about 1.0 in, (ii) a high tack coefficient of at least 1.50 as measured via ASTM test method D1894, and (iii) an upper foam layer having an Impression Load Deflection (ILD) value of about 50; and (b) a lower foam layer having (i) a lower foam layer thickness of from about 0.5 in to about 1.5 in, (ii) an average breathability of about 5.5 standard cubic feet per minute (SUM) as measured via ASTM 3574 Test G, and (iii) an Impression Load Deflection (ILD) value of about 40.

19. A method of making the patient safety surgical pad of claim 1, said method comprising:
attaching the high coefficient of friction layer along the lower fiber-containing layer surface of the fiber-containing layer; and
attaching the foam layer along the upper fiber-containing layer surface of the fiber-containing layer,
wherein the method may further comprise one or more optional features and/or steps comprising:
the foam layer comprises two or more foam layers, and the method further comprises combining the two or more foam layers with one another;
each of said attaching steps comprises utilizing an adhesive to attach the high coefficient of friction layer and the foam layer to the fiber-containing layer;
stitching one or more layers to one another via stitching;
the step of attaching the high coefficient of friction layer along the lower fiber-containing layer surface of the fiber-containing layer comprises attaching a high coefficient of friction layer that has a length L_{HL} that is less than an overall length L_{O} of the fiber-containing layer; and
a lower surface portion of the lower fiber-containing layer surface is (i) below the foam layer and (ii) not covered by the high coefficient of friction layer.

20. A method of using the patient safety surgical pad of claim 1, said method comprising one or more steps comprising:
supporting a patient on the patient safety surgical pad;
positioning the patient safety surgical pad along an operating room table;
lifting a patient via the patient safety surgical pad;
transferring a patient from one location to another location via the patient safety surgical pad; and
cutting thru a lower surface portion of the patient safety surgical pad, the lower surface portion being (i) below the foam layer and (ii) not covered by the high coefficient of friction layer.
